(19) United States
(12) Patent Application Publication
(10) Pub. No.: US 2010/0319248 A1
(43) Pub. Date: Dec. 23, 2010

(54) DEVICE TOTRASFER AND STORE FRESHWATER, COLLECT RAINFALL & GROW VEGETATION

(76) Inventor: Pandurnena Reyankar Krishna Prasad, Bangalore (IN)

Correspondence Address: c/o Mr. Madhvesh, 677 Bounty Drive, Apt 102, Foster City, CA, 94404, US

(21) Appl. No.: 12/735,599

(22) PCT Filed: Jan. 30, 2009
(86) PCT No.: PCT/IN2009/000068

§ 371 Date: Jul. 30, 2010

(30) Foreign Application Priority Data
Feb. 1, 2008 (IN) 286/CHE/2008
Feb. 1, 2008 (IN) 287/CHE/2008
Feb. 1, 2008 (IN) 288/CHE/2008
Feb. 1, 2008 (IN) 289/CHE/2008
Feb. 14, 2008 (IN) 368/CHE/2008
Feb. 14, 2008 (IN) 369/CHE/2008

(51) Int. Cl. A01G 25/00

(52) U.S. Cl. 47/48.5

(57) ABSTRACT

A device, system, and method of transfer and store fresh water on the sea surface, to collect rain fall occurring on the sea, and to grow vegetation on the sea through discharged fresh water from rivers and above collected rain water are disclosed. In one embodiment, a device includes a floating channel to transfer fresh water is made of flexible plastic film separator surrounded by a leak detection chambers with sensing electrodes, a rain water collecting film held up by floats to collect rain water falling on the sea is coupled to the floating channel, a flexible film separator held by floats having storage of fresh water is used to grow vegetation to absorb carbon dioxide from the atmosphere, and a towing system to ensure a correct designated position of the floating channel giving dynamic stabilization controlled through a triangulation technique based on a radio transmitter's location on a coast.

### CLAIMS OF PRIORITY

This patent application claims priority from the Provisional Patent Application No. 286/CHE/2008 filed on 1, Feb. 2008.

### FIELD OF TECHNOLOGY

This disclosure relates generally to technical fields of transfer, and store a fresh water through channel system, and in one embodiment to a device to transfer and store fresh water on the sea surface, to collect rain fall occurring on the sea, and to grow vegetation on the sea. the fresh water being that discharged from rivers and above collected rain water.

### SUMMARY

A device, system, and method to transfer and store fresh water on the sea surface, to collect rain fall occurring on the sea, and to grow vegetation on the sea. the fresh water being that discharged from rivers and above collected rain water are disclosed. In one aspect, a device includes a floating channel to transfer fresh water is made of flexible plastic film separator surrounded by a leak detection chambers with sensing electrodes, a floating channel to float on the surface of the sea, a flexible film separator used to separate between fresh water, and the salt water, An Isolator Connector with valve, to connect a channel section with a lift up floats and detachable weight, and an attachment for towing, and anchorage, A rain water collecting film held up by floats to collect rain water falling on the sea is coupled to the floating channel, Floats being multi-chambered with an entrapped air to give buoyancy, and to hold the flexible film, the plastic of floats having ultra violet protection chemicals incorporated,

A discharge out let to connect between the flexible film, and a floating channel to transfer the fresh water to the floating channel, A flushing out let used to flush out salt contamination when required, A flexible film separator held by floats having storage of fresh water is used to grow vegetation to absorb carbon dioxide from the atmosphere, A harvesting mechanism coupled to a boom carrying brushes to harvest vegetation, and A towing system to ensure a correct designated position of the floating channel and give dynamic stabilization is controlled through a triangulation technique based on a radio transmitter's location on a coast.

The device may also include the plastic film separator is surrounded by the leakage detection chamber is made of plastic film with embedded wires, the wire being at least of metal wire and conducting polymer wire to which is attached stainless steel electrodes. Increase in electrical conductivity with salt water mixing in case of leakage enables detection of leakage and facilitate repair, the required electronic system is mounted on Isolator Connector. The device further includes the Towing boat with plastic tow lines uses an error signal generated through a microprocessor at least one from triangulation signal transmitted by three antennas on coast, and by GPS signal tow the channel into correct designated position when drifted by waves, and wherein the anchorage is taken where necessary from sea floor by anchor hooks and weight connected by plastic ropes.

In another aspect, the vegetation growing section may be made of plastic film reinforced with fiber threads, which acts as separator between fresh water and sea water, storing the fresh water, the plastic film being held and surrounded by plastic multi chambered floats, the plastic film having a thin upper layer of new synthesized plastic to enable proper sealing, and a thick bottom layer is made out of a recycled plastic component for strength, the floats have small magnets attached to guide the harvester mechanism.

In yet another aspect, the vegetation growing section may receive fresh water as rain falling in the section and freshwater delivered from rainwater collected by the rainwater collecting section and from discharge of rivers transferred through open type and closed type channels. In addition, the vegetation may absorb carbon dioxide from the atmosphere through an azola plant, a algae and a rice plant which grows in the stored fresh water, the rice plant being grown by hydroponics method of soil less culture, and the rice being supported by a mesh of plastic float filled with air to provide support and anchorage. Algae is grown using sea water where necessary, and vegetation growing section enables application of fertilizer thereby enabling good growth. The peripheral border of area having vegetation growing sections has plastic mesh net suspended downwards by weights and held up by floats to give protection from fish where necessary. The harvester mechanism coupled to a boom carrying brushes to harvest vegetation is automated with robotic systems fitted on a small boat.

The device, systems, and methods disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a device illustrating an open, and closed type channel to transfer and store a fresh water that may be connected to a rain water collector, and a vegetation section, according to one embodiment.

FIG. 2 is a cross section view of the open channel, according to one embodiment.

FIG. 3 is a top view of the open channel, according to one embodiment.

FIG. 4 is a cross section view of the closed channel, according to one embodiment.

FIG. 5 is a side view of the closed channel, according to one embodiment.

FIG. 6 is a side view of the open channel, according to one embodiment.

FIG. 7 is a side view of the closed channel, according to one embodiment.

FIG. 8 is a cross section view of a towing boat, according to one embodiment.

FIG. 9 is a system view of below chamber with isolator to cross ships, according to one embodiment.

FIG. 10 is a system view of a ‘U’ shaped connectivity chamber, according to one embodiment.

FIG. 11 is a cross section view of a rain water collecting film, according one embodiment.

FIG. 12 is a top view of a rain water collecting film, according one embodiment.

FIG. 13 is a cross section view of vegetation growing section, according to one embodiment.

FIG. 14 is a cross section view of vegetation growing section that includes spacer mesh, and floating mesh, according to one embodiment.

FIG. 15 is a top view of vegetation growing section, according to one embodiment.

FIG. 16 is a system view of a harvesting mechanism, according to one embodiment.

FIG. 17 is a system view illustrating rotating boom, according to one embodiment.

Other features of the present embodiments will be apparent from the accompanying drawings and from the detailed description that follows.

### DETAILED DESCRIPTION

A device, system and method to transfer and store fresh water on the sea surface, to collect rain fall occurring on the sea, and to grow vegetation on the sea. the fresh water being that discharged from rivers and above collected rain water are disclosed. Although the present embodiments have been described with reference to specific example embodiments, it will be evident that various modifications and changes may be made to these embodiments without departing from the broader spirit and scope of the various embodiments.

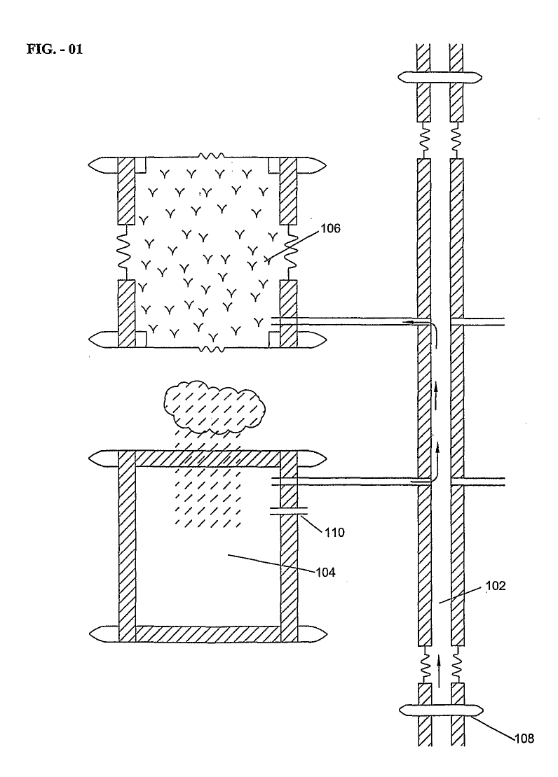

FIG. 1 is a system view of a device illustrating an open, and closed type channel to transfer and store a fresh water that may be connected to a rain water collector, and a vegetation section, according to one embodiment. Particularly, FIG. 1 illustrates an open channel 102, a rain water collecting film 104, a vegetation growing section 106, an isolator connector 108, and a flush outlet 110, according to one embodiment.

The open channel 102 (e.g., a plastic component) may be used to transfer a fresh water which may be discharged from the river is floating on the surface of the sea. The rain water collecting film 104 may be used to collect the rain water falling on the sea that may be coupled to the floating open channel 102. The vegetation growing section 106 (e.g., made of plastic film) may act as a separator between a fresh water and a sea water. This section having storage of fresh water is used for vegetation to absorb carbon dioxide from the atmosphere. The vegetation growing section 106 is connected to the open channel 102. The isolator connector 108 (e.g., may be made of rigid plastic frame with latch) with a drop down valve may be used to connect a channel section with a lift up floats with detachable weights. The isolator connector 108 may also be used to detach, and attached back the floating channel during severe storm, to pass wave energy, to prevent damage to the device, and accidental collusion with ships. The flush out let 110 of the rain water collecting film 104 may be used to flush out the salt contamination as and when required.

In example embodiment, the open channel 102 with the isolator connector 108 may be coupled to the rain water collecting film 104, and the vegetation growing section 106 to transfer and store the fresh water 206.

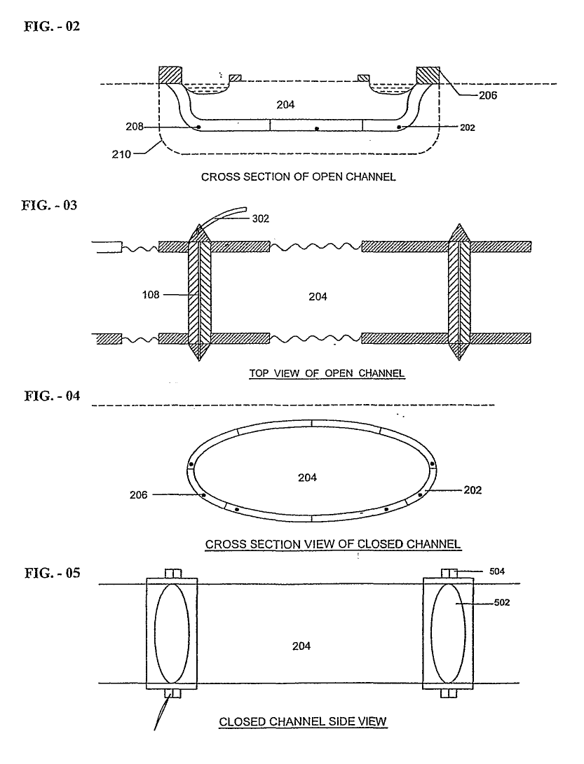

FIG. 2 is a cross section view of the open channel, according to one embodiment. Particularly, FIG. 2 illustrates a leak protection chamber 202, fresh water 204, a float 206, electrodes 208, and a netting 210, according to one embodiment.

The leak protection chamber 202 may be used to detecting the leakages of fresh water in the channel (e.g., may be open type, and closed type channel). The fresh water 204 may be the pure and sweet water discharged from the rivers that may be transferred from the channel. The float 206 (e.g., flexible, and made of plastic film component) may be connected at the end of the channel which may be used to float the channels on the surface of the sea. The electrodes 208 attached in the channel is used to sense the salt water leakage in the channel. The netting 210 may be spread over to protect the channel from the fish, and sharks.

In example embodiment, the open channel 102 that may be connected to the leak detection chamber 202, the electrodes 208. The open channel 102 may be connected to the float 206 at both the ends of the channel. The netting 210 is used to protect the channel.

FIG. 3 is a top view of the open channel, according to one embodiment. Particularly, FIG. 3 illustrates the isolator 108, the fresh water 204, the float 206, and the tow line 302, according to one embodiment.

The towing line 302 made of plastic may be used error signal to generated through the microprocessor from triangulation signal transmitted by three antennas on the coast for correct designated position of the floating channel.

In example embodiment, the top of the open channel 102 may be attached with the isolator connector 108 with a tow line 302.

FIG. 4 is a cross section view of the closed channel, according to one embodiment. Particularly, FIG. 4 illustrates the leak detection chamber 202, the fresh water 204, and the electrodes 206, according to one embodiment.

FIG. 4 illustrates another type channel called the closed type channel to collect and transfer the fresh water 204 along with the electrodes 206 and the leak detection chamber 202 which may be used to detect the salt water leakage in the channel. The functionality of the open type channel and the closed type channel is similar.

FIG. 5 is a side view of the closed channel, according to one embodiment. Particularly, FIG. 5 illustrates the fresh water 204, a drop down valve 502, and the latching connector to drop down valve 504, according to one embodiment.

The drop down valve 502 (e.g., the drop down valve, the butterfly valve, and the flap valve) may be connected to the isolator connector may be directional to take advantage of wave to get forward flow, and to take back flow of the device. The latching connector to drop down valve 504 may be used to control the drop down valve of the isolator connector.

FIG. 5 illustrates the drop down valve 502 with latching connector of the isolator of the closed channel.

FIG. 6 is a side view of the open channel, according to one embodiment. Particularly, FIG. 6 illustrates the isolator 108, the fresh water 204, the float 206, the tow line 302, the drop down valve 502, a signal board with blinking LED 602, a damper film structure 604, an anchorage to sea floor 606, and a detachable weight 608, according to one embodiment.

The signal board with blinking. LED 602 is carried on the isolator connector to warm ships, and fishing boat from approaching the channel. The damper film structure 604 may be suspended in deeper part of sea, is attached to the Isolator Connector 108. The anchorage to sea floor 606 may be taken wherever necessary by anchor hooks connected to the plastic ropes for stabilization of the floating channel. The detachable weight 608 may be provided to the isolator connector 108 of the floating channel during severe storm, and accidental collusion with the ships.

FIG. 6 illustrates a side view of the open channel having isolator connector 108 connected upwardly to the signal board with blinking LED 602, the drop down valve 502. The anchorage to sea floor 606 and the damper film structure 604 are also provided to the isolator connector 108 for stabilization of the device.

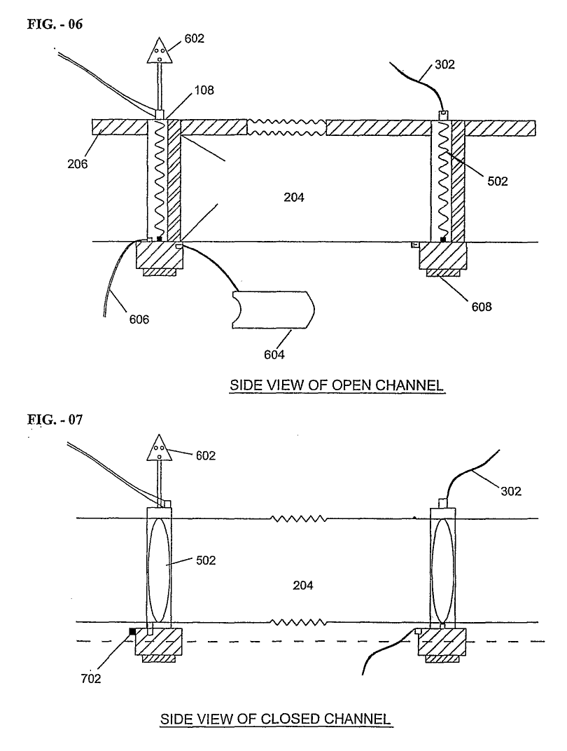

FIG. 7 is a side view of the closed channel, according to one embodiment. Particularly, FIG. 7 illustrates the fresh water 204, the tow line 302, the drop down valve 502, the signal board with blinking LED 602, and electrodes for shark repulsion 702, according to one embodiment.

The electrodes 702 (e.g., may be stainless steel) attached to the isolator connector 108 downwardly may be used to repel sharks from the device.

FIG. 8 is a cross section view of a towing boat, according to one embodiment. Particularly, FIG. 8 illustrates the tow line 302, an antenna 802A-C, an antenna 804, and a microprocessor 806, according to one embodiment.

The antenna 802A-C may be mounted on the coast to transmit triangulation signal for the corrected designated position of the floating channel. The antenna 804 is mounted in the towing boat to keep the channel in correct position when drifted by waves. The microprocessor 806 may, be used to generate error signal that may be used by the towing boat with plastic tow line to place the floating channel in correct designated position when drifted by waves.

FIG. 8 illustrates the towing boat with plastic tow line along with the antenna 804 and the microprocessors 806 using the error signal generated through the microprocessor 806 from the triangulation signal transmitted by the three antennas on the coast, and by GPS signal tow the channel into correct designated position when drifted by waves.

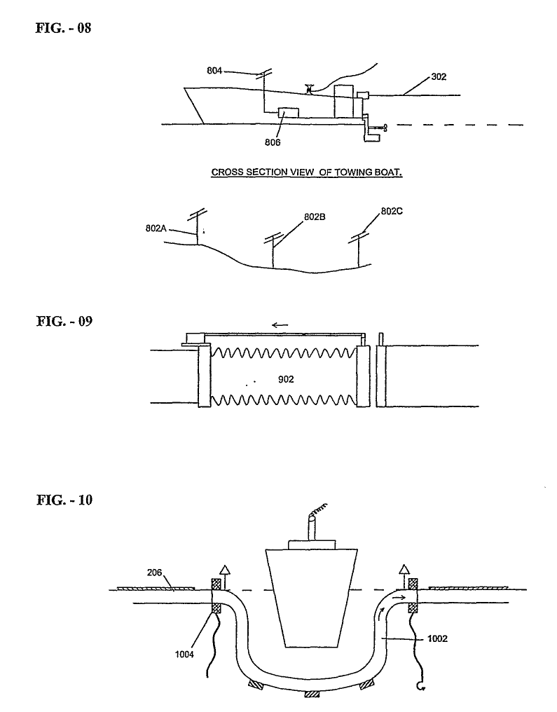

FIG. 9 is a system view of below chamber with isolator to cross ships, according to one embodiment. Particularly, FIG. 9 illustrates a below chamber 902. The below chamber 902 may be pulled in by a pair of cables that may be driven by motor to allow large ships. The open type, and the closed type channels may have below chambers 902.

FIG. 10 is a system view of a ‘U’ shaped connectivity chamber, according to one embodiment. Particularly, FIG. 10 illustrates the floating channel having ‘U’ shape connecting chamber 1002 (e.g., made of rigid material with swivel joints) may be used to allow the ships to cross the channel without damaging the device. The ‘U’ shaped connecting chamber 1002 may be in horizontal position which may be dip down to vertical position using the ships force allowing ships to cross and return to horizontal position after the crossing of ships.

FIG. 11 is a cross section view of a rain water collecting film, according one embodiment. Particularly, FIG. 11 illustrates the flush outlet 110 which has a valve, and a discharge outlet 1102 which has a valve, according to one embodiment. FIG. 11 illustrates the collection of rain water through the rain water collecting film coupled to the float 206. The discharge outlet 1102 may be used to discharge the collected rain water to the open and closed type channels. Condensed water collector 1104 is provided on the underside of the film to collect condensed fresh water that condenses on underside.

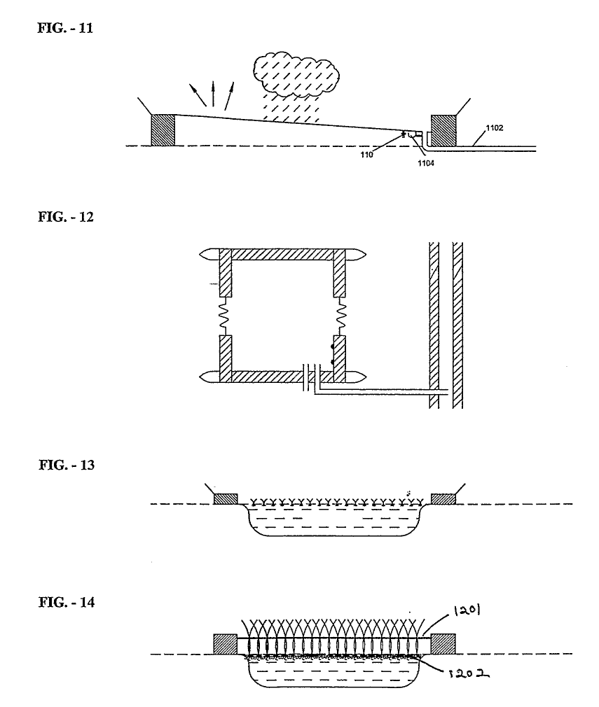

FIG. 12 is a top view of a rain water collecting film, according one embodiment. Particularly, FIG. 12 illustrates the top view of the rain water collecting film that may be connected to the open channel 102 along with flush outlet 110, and the discharge outlet 1102.

FIG. 13 is a cross section view of vegetation growing section, according to one embodiment. Particularly, FIG. 13 illustrates the cross section view of the vegetation growing section 106 (e.g., made of plastic film to act as separator between fresh water, and salt water) allowing storage of fresh water in the floating section which may be used to grow vegetation (e.g., may be azola plant) to absorb carbon dioxide from atmosphere.

FIG. 14 is a cross section view of vegetation growing section that includes spacer mesh 1201, and floating mesh 1202, according to one embodiment. Particularly,

FIG. 14 illustrates growing of rice plant in the vegetation growing section 106 that may be supported by a mesh of plastic float filled with air to provide support.

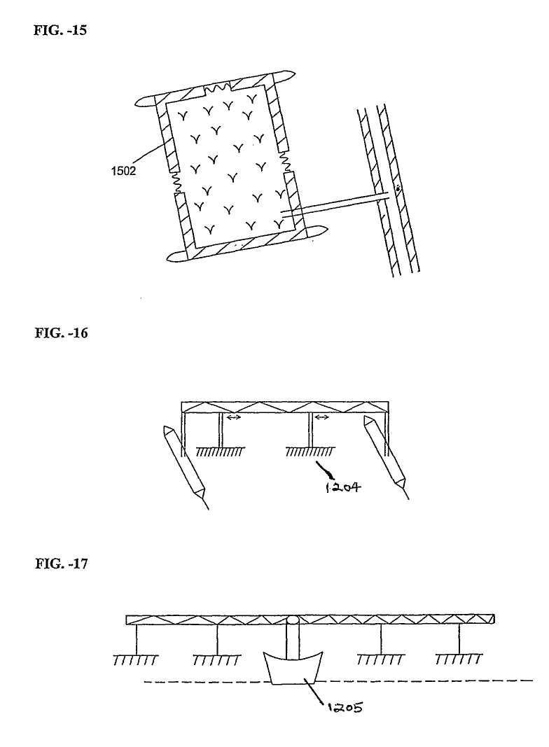

FIG. 15 is a top view of vegetation growing section, according to one embodiment. Particularly, FIG. 15 illustrates magnets 1502 may be attached to the float 206 to guide the harvesting mechanism.

FIG. 16 is a system view of a harvesting mechanism, according to one embodiment. Particularly, FIG. 16 illustrates the harvesting mechanism that may be coupled to the boom carrying brushes, and cable drive to harvest vegetation.

FIG. 17 is a system view illustrating rotating boom, according to one embodiment. Particularly, FIG. 17 illustrates the harvesting mechanism which may be coupled to the boom carrying brushes 1204 to harvest vegetation may be automated with robotic system fitted on a small boat 1205.

Although the present embodiments have been described with reference to specific example embodiments, it will be evident that various modifications and changes may be made to these embodiments without departing from the broader spirit and scope of the various embodiments.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

I claim:

1. A device comprising:
a floating channel to transfer fresh water is made of flexible plastic film separator surrounded by a leak detection chambers with sensing electrodes;
a floating channel to float on the surface of the sea;
a flexible film separator used to separate between fresh water, and the salt water;
an Isolator Connector with valve, to connect a channel section with a lift up floats and detachable weight, and an attachment for towing, and anchorage;
a rain water collecting film held up by floats to collect rain water falling on the sea is coupled to the floating channel;
floats being multi-chambered with an entrapped air to give buoyancy, and to hold the flexible film, the plastic of floats having ultra violet protection chemicals incorporated;
a discharge out let to connect between the flexible film, and a floating channel to transfer the fresh water to the floating channel;
a flushing out let used to flush out salt contamination when required;
a flexible film separator held by floats having storage of fresh water is used to grow vegetation to absorb carbon dioxide from the atmosphere;
a harvesting mechanism coupled to a boom carrying brushes to harvest vegetation; and
a towing system to ensure a correct designated position of the floating channel and give dynamic stabilization is controlled through a triangulation technique based on a radio transmitter's location on a coast.

2. The device as claimed in claim 1:
wherein the floating channel is flexible, and made at least of plastic film reinforced with fiber threads, and of polymeric fabric coated with plastic and, of rubber sheet reinforced with fiber thread and metal cable for strength, wherein the floating channel is at least one of a open type channel, and a closed type channel, surrounded by a plastic netting mesh to protect from fish, and the connected stainless steel electrodes to repel sharks; and
Wherein the plastic film separator is surrounded by the leakage detection chamber is made of plastic film with embedded wires, the wire being at least of metal wire and conducting polymer wire to which is attached stainless steel electrodes. Increase in electrical conductivity of fresh water in chambers with salt water mixing in case of leakage enables detection of leakage and facilitate repair, the required electronic system is mounted on Isolator Connector.

3. The device as claimed in claim 1:
Wherein a spillover channel is connected in the floating open type channel to prevent mixing between the fresh water, and the salt water due to splash which gets discharged to the sea at discharge out near Isolator Connector, and wherein the fresh water is at least one of a rain water, and water coming as discharge from river which is transferred to at least vegetation growing section on the sea and to arid lands requiring freshwater to grow vegetation and to other rivers for pumping inwards to meet freshwater requirement thereby interlinking rivers.

4. The device as claimed in claim 1:
wherein the Isolator Connector can detach, attached back the floating channel during severe storm, and accidental collusion with ships and whales, and wherein the Isolator Connector is made of rigid plastic frame with latch, and at least one of a dropdown valve, a butter fly valve, and a flap valve, and wherein valve is directional to take advantage of wave to get forward flow, and to prevent back flow, and wherein the Isolator Connector is having lift up floats with detachable weights, to detach, and reattach after being held by separate floats, to help pass wave energy and prevent damage to the device, wherein the Isolator Connector has the attachment hooks for tow lines and the plastic anchorage ropes, and wherein the structure supporting a wave damping film which is suspended in deeper part of sea, is attached to the Isolator Connector, and the sign boards, and LED flashing indicator is carried on Isolator Connector to warn ships, and fishing boat from approaching the channel. Reflective film on float indicate presence of channel to boats and ships.

5. The device as claimed in claim 1:
wherein the Towing boat with plastic tow lines uses an error signal generated through a microprocessor at least one from triangulation signal transmitted by three antennas on coast, and by GPS signal tow the channel into correct designated position when drifted by waves, and wherein the anchorage is taken where necessary from sea floor by anchor hooks and weight connected by plastic ropes, and where in dynamic stabilization is provided with the plastic ropes connected to spool driven by motor on the coast. Stabilization is provided by motor driven spool wound with plastic tow line and connected to channels.

6. The device as claimed in claim 1:
wherein the open type, and closed type channel to have ‘U’ shaped connecting chamber made of rigid material with sievel joints, to allow the ships to cross the channel, and wherein the ‘U’ shaped connecting chamber can be in horizontal position which dip down to vertical position using the ships force thereby allowing ships to cross and return to horizontal position after the crossing the ships, and wherein the open type, and closed type channel have Bellow chambers pulled in by a pair of cables driven by motor to allow large ships to cross. Pumps provided where needed taking anchourage from sea floor to increase flow rate when required.

7. The device as claimed in claim 1:
Wherein the plastic film reinforced with fiber threads, for collecting rain is at least one of a reflective metalised plastic film to reflect incident solar radiation, and a transparent film as per requirement and with the plastic having ultra violet radiation protection chemicals added.
Wherein the film based multi-chambered float and the rain collecting film having a thin upper layer of newly synthesized plastic to enable proper sealing, and a thick bottom layer is made out of a recycled plastic component for strength, the floats having wanes being used to hold the flexible film in a sloping gradient. A flushing outlet with valve to flush out salt contamination and a discharge out with valve to connect to open and closed type channels is provided. A condensed water collector is provided on the lower side of the film to collect condensed fresh water which joins the discharge outlet

8. The device as claimed in claim 1:
wherein the vegetation growing section is made of plastic film reinforced with fiber threads, which acts as separator between fresh water and sea water, storing the fresh water, the plastic film being held and surrounded by plastic multi chambered floats, the plastic film having a thin upper layer of new synthesized plastic to enable proper sealing, and a thick bottom layer is made out of a recycled plastic component for strength, the floats have small magnets attached to guide the harvester mechanism. The vegetation growing section receives fresh water as rain falling in the section and freshwater delivered from rainwater collected by the rainwater collecting section and from discharge of rivers transferred through open type and closed type channels; and
Wherein the vegetation to absorb carbon dioxide from the atmosphere is at least one of an azola plant, a algae and a rice plant which grows in the stored fresh water, the rice plant being grown by hydroponics method of soil less culture, and wherein the rice being supported by a mesh of plastic float filled with air to provide support and anchorage. Algae is grown using sea water where necessary wherein vegetation growing section enables application of fertilizer thereby enabling good growth. Wherein the peripheral border of area having vegetation growing sections has plastic mesh net suspended downwards by weights and held up by floats to give protection from fish where necessary.

9. The device as claimed in claim 1:
Wherein the open type, and closed type channel having a sleeve of plastic film to be moved to any leaky area, and cover the same until repair is undertaken, wherein an extra thin layer of plastic film is used to surround the open type and closed type channels to clean barnacles in places where required. Borders of vegetation growing section have plastic film suspended downwards by weight and held up by float to reduce oxygen content underneath the vegetation growing section thereby preventing barnacles.

10. The device as claimed in claim 1:
Wherein the harvester mechanism coupled to a boom carrying brushes to harvest vegetation is automated with robotic systems fitted on a small boat. The boom is at least of type held at the sides by floats and type held at the centre to rotate and reach the vegetation.

11. The device to transfer and store fresh water on the sea surface, to collect rain fall occurring on the sea, and to grow vegetation on the sea. the fresh water being that discharged from rivers and above collected rain water as herein described and illustrated in figures of accompanying drawings.
